(19) United States
(12) Patent Application Publication
(10) Pub. No.: US 2025/0174687 A1
(43) Pub. Date: May 29, 2025

(54) FUEL CELL SYSTEM AND METHOD OF CONTROLLING THE SAME

(71) Applicants: Hyundai Motor Company, Seoul (KR); Kia Corporation, Seoul (KR)

(72) Inventor: Hee Won KOO, Suwon-Si (KR)

(73) Assignees: Hyundai Motor Company, Seoul (KR); Kia Corporation, Seoul (KR)

(21) Appl. No.: 18/602,839

(22) Filed: Mar. 12, 2024

(30) Foreign Application Priority Data
Nov. 28, 2023 (KR) 10-2023-0168433

(51) Int. Cl. H01M 8/04746; H01M 8/04089; H01M 8/0438

(52) U.S. Cl. CPC H01M 8/04753; H01M 8/04097; H01M 8/04388; H01M 2250/20

(57) ABSTRACT

A fuel cell system includes a fuel cell stack including an anode configured to be supplied with hydrogen and a cathode configured to be supplied with air, a hydrogen supply line connected to an inlet of the anode and configured to supply the hydrogen to the fuel cell stack, and a bypass line including a first end portion connected to the hydrogen supply line and a second end portion connected to an outlet of the anode, obtaining an advantageous effect of ensuring performance and operational efficiency and improving stability and reliability.

### CROSS-REFERENCE TO RELATED APPLICATION

The present application claims priority to Korean Patent Application No. 10-2023-0168433 filed on Nov. 28, 2023, the entire contents of which is incorporated herein for all purposes by this reference.

### BACKGROUND OF THE PRESENT DISCLOSURE

### Field of the Present Disclosure

The present disclosure relates to a fuel cell system and a method of controlling the same, and more particularly, to a fuel cell system and a method of controlling the same, which are capable of ensuring performance and operational efficiency and improving stability and reliability.

### Description of Related Art

A fuel cell electric vehicle (FCEV) produces electrical energy from an electrochemical reaction between oxygen and hydrogen in a fuel cell stack and travels by operating a motor.

The fuel cell electric vehicle may continuously generate electricity, regardless of a capacity of a battery, by being supplied with fuel (hydrogen) and air from the outside thereof, and thus has high efficiency, and emits almost no contaminant. By these advantages, continuous research and development is being conducted on the fuel cell electric vehicle.

In general, the fuel cell electric vehicle may include a fuel cell stack configured to generate electricity by an oxidation-reduction reaction between hydrogen and oxygen, a fuel supply device configured to supply fuel (hydrogen) to the fuel cell stack, and an air supply device configured to supply the fuel cell stack with reaction air (oxygen) which is an oxidant required for an electrochemical reaction.

Meanwhile, when a pressure deviation (hydrogen pressure deviation) occurs between an anode inlet and an anode outlet of the fuel cell stack, the performance and operational efficiency of the fuel cell stack deteriorate. Furthermore, air in a cathode of the fuel cell stack is diffused to the anode of the fuel cell stack, which degrades the cathode. Therefore, it is necessary to minimize the hydrogen pressure deviation in the fuel cell stack.

However, generally, hydrogen pressure in an anode outlet portion of the fuel cell stack is lower than air pressure in a cathode inlet portion during a process of initially starting the fuel cell stack, which may cause a problem in that the air in the cathode is diffused to the anode, and the cathode is degraded (corroded).

Therefore, recently, various studies have been conducted to minimize the diffusion of air to the anode in the fuel cell and improve stability and reliability, but the study results are still insufficient. Accordingly, there is a need to develop a technology to minimize the diffusion of air to the anode in the fuel cell and improve stability and reliability.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a fuel cell system and a method of controlling the same, which are configured for ensuring performance and operational efficiency and improving stability and reliability.

The present disclosure has been made in an effort to minimize diffusion of air to an anode caused by reversal of pressure between a cathode and the anode in a fuel cell stack and improve stability and reliability.

Among other things, the present disclosure has been made in an effort to minimize diffusion of air to a surface of the anode caused by pressure in the cathode at a position adjacent to an anode outlet of the fuel cell stack during a process of initially starting the fuel cell stack.

The present disclosure has also been made in an effort to minimize a pressure deviation for each position in the surface of the anode and stably ensure an output of the fuel cell stack.

The present disclosure has also been made in an effort to improve durability of the fuel cell stack.

The present disclosure has also been made in an effort to more efficiently control a working pressure in the anode and improve a degree of freedom of the working pressure in the anode.

The objects to be achieved by the exemplary embodiments are not limited to the above-mentioned objects, but also include objects or effects which may be understood from the solutions or embodiments described below.

To achieve the above-mentioned objects, an exemplary embodiment of the present disclosure provides a fuel cell system including: a fuel cell stack including an anode configured to be supplied with hydrogen and a cathode configured to be supplied with air; a hydrogen supply line connected to an inlet of the anode and configured to supply the hydrogen to the fuel cell stack; and a bypass line including a first end portion connected to the hydrogen supply line and a second end portion connected to an outlet of the anode.

This is to ensure performance and operational efficiency of the fuel cell system and improve stability and reliability.

That is, generally, hydrogen pressure in an anode outlet portion of the fuel cell stack is lower than air pressure in a cathode inlet portion during a process of initially starting the fuel cell stack, which may cause a problem in that the air in the cathode is diffused to the anode, an output of the fuel cell stack becomes unstable, and the cathode is degraded (corroded).

In contrast, in the exemplary embodiment of the present disclosure, hydrogen is selectively supplied to the outlet of the anode through the bypass line that connects the hydrogen supply line and the outlet of the anode. Therefore, it is possible to obtain an advantageous effect of minimizing a pressure deviation between the inlet of the anode and the outlet of the anode.

Among other things, in the exemplary embodiment of the present disclosure, hydrogen is supplied to the outlet of the anode during a process of initially starting the fuel cell stack, which may minimize the diffusion of air to the anode caused when a pressure at a position of the outlet of the anode is lower than a pressure in the inlet of the cathode. Therefore, it is possible to obtain an advantageous effect of ensuring the performance and operational efficiency of the fuel cell stack and minimizing degradation (corrosion) of the cathode.

According to the exemplary embodiment of the present disclosure, the fuel cell system may include: a recirculation line including a first end portion connected to the outlet of the anode and a second end portion connected to the hydrogen supply line, the recirculation line being configured to selectively supply hydrogen, which is discharged from the outlet of the anode, back to the inlet of the anode, in which the second end portion of the bypass line is connected to the recirculation line.

According to the exemplary embodiment of the present disclosure, the fuel cell system may include: an ejector mounted in the hydrogen supply line, in which the first end portion of the bypass line and the second end portion of the recirculation line are connected to the ejector.

According to the exemplary embodiment of the present disclosure, the ejector may include: a first tube portion, a second tube portion connected to a downstream side of the first tube portion and having a cross-sectional area smaller than a cross-sectional area of the first tube portion; and a third tube portion connected to a downstream side of the second tube portion and having a cross-sectional area larger than the cross-sectional area of the second tube portion, in which the second end portion of the recirculation line is connected to the second tube portion, the first end portion of the bypass line is connected to the first tube portion, and the second end portion of the bypass line is connected to the recirculation line.

According to the exemplary embodiment of the present disclosure, the fuel cell system may include: a valve portion configured to selectively open or close the bypass line based on a pressure difference between the inlet and the outlet of the anode.

The valve portion may have various structures configured for selectively opening or closing the bypass line based on the supply pressure of hydrogen to be supplied to the anode.

According to the exemplary embodiment of the present disclosure, the valve portion may include a first valve configured to be selectively movable from a first closing position at which the first valve closes the bypass line to a first opening position at which the first valve opens the bypass line, the first valve may be configured to move to the first opening position under a condition in which a difference between a supply pressure of the hydrogen and a pressure of the hydrogen in the recirculation line is a preset first pressure, and the first valve may be configured to move to the first closing position under a condition in which the difference between the supply pressure of the hydrogen and the pressure of the hydrogen in the recirculation line is lower than the first pressure.

The first pressure, which allows the first valve to open the bypass line, may be variously changed in accordance with required conditions and design specifications. The present disclosure is not restricted or limited by the operation time point (the first pressure) of the first valve.

According to the exemplary embodiment of the present disclosure, the first pressure may be defined to correspond to an initial start mode of the fuel cell stack.

According to the exemplary embodiment of the present disclosure, the valve portion may include a second valve configured to be selectively movable from a second closing position at which the second valve closes the bypass line to a second opening position at which the second valve opens the bypass line, the second valve may be configured to move to the second opening position under a condition in which the supply pressure of the hydrogen is a predetermined reference pressure, and the second valve may be configured to move to the second closing position under a condition in which the supply pressure of the hydrogen is a second pressure lower than the reference pressure.

The second pressure, which allows the second valve to close the bypass line, may be variously changed in accordance with required conditions and design specifications.

According to the exemplary embodiment of the present disclosure, the second pressure may be defined to correspond to a general operation mode of the fuel cell stack.

According to the exemplary embodiment of the present disclosure, the valve portion may include a third valve configured to be selectively movable from a third closing position at which the third valve closes the bypass line to a third opening position at which the third valve opens the bypass line, the third valve may be configured to move to the third opening position under a condition in which the supply pressure of the hydrogen is equal to or lower than the first pressure, and the third valve may be configured to move to the third closing position under a condition in which the supply pressure of the hydrogen is a third pressure higher than the first pressure.

The third pressure, which allows the third valve to close the bypass line, may be variously changed in accordance with required conditions and design specifications.

According to the exemplary embodiment of the present disclosure, the third pressure may be defined to correspond to a high-output operation mode of the fuel cell stack.

Another exemplary embodiment of the present disclosure provides a method of controlling a fuel cell system, which includes a fuel cell stack including an anode configured to be supplied with hydrogen and a cathode configured to be supplied with air, a hydrogen supply line connected to an inlet of the anode and configured to supply the hydrogen to the fuel cell stack, and a bypass line including a first end portion connected to the hydrogen supply line and a second end portion connected to an outlet of the anode, the method including: detecting a differential pressure between the outlet of the anode and an inlet of the cathode during a process of initially starting the fuel cell stack; and opening the bypass line to supply the hydrogen to the outlet of the anode when the differential pressure between the outlet of the anode and the inlet of the cathode is equal to or greater than a predetermined reference differential pressure.

According to another exemplary embodiment of the present disclosure, the fuel cell system may include a recirculation line including a first end portion connected to the outlet of the anode and a second end portion connected to the hydrogen supply line, the recirculation line being configured to selectively supply hydrogen, which is discharged from the outlet of the anode, back to the inlet of the anode, the other end portion of the bypass line may be connected to the recirculation line, and in the opening of the bypass line, the hydrogen may be supplied to the outlet of the anode via the bypass line and the recirculation line.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view for explaining a fuel cell system according to an exemplary embodiment of the present disclosure.

FIG. 2 is a view for explaining a valve portion of the fuel cell system according to the exemplary embodiment of the present disclosure.

FIG. 3, FIG. 4, and FIG. 5 are views for explaining a movement route for hydrogen in an initial start mode of a fuel cell stack in the fuel cell system according to the exemplary embodiment of the present disclosure.

FIG. 6, FIG. 7, and FIG. 8 are views for explaining a movement route for hydrogen in a general operation mode of the fuel cell stack in the fuel cell system according to the exemplary embodiment of the present disclosure.

FIG. 9 is a view for explaining a movement route for hydrogen in a high-output operation mode of the fuel cell stack in the fuel cell system according to the exemplary embodiment of the present disclosure.

FIG. 10 is a view for explaining electric currents in an inlet and an outlet of an anode in the fuel cell system according to the exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings.

However, the technical spirit of the present disclosure is not limited to various exemplary embodiments described herein but may be implemented in various different forms. At least one of the constituent elements in the exemplary embodiments of the present disclosure may be selectively combined and substituted for use within the scope of the technical spirit of the present disclosure.

Furthermore, unless otherwise specifically and explicitly defined and stated, the terms (including technical and scientific terms) used in the exemplary embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

Furthermore, the terms used in the exemplary embodiments of the present disclosure are for explaining the embodiments, not for limiting the present disclosure.

In the present specification, unless particularly stated otherwise, a singular form may also include a plural form. The expression “at least one (or one or more) of A, B, and C” may include one or more of all combinations that may be made by combining A, B, and C.

Furthermore, the terms such as first, second, A, B, (a), and (b) may be used to describe constituent elements of the exemplary embodiments of the present disclosure.

These terms are used only for discriminating one constituent element from another constituent element, and the nature, the sequences, or the orders of the constituent elements are not limited by the terms.

Furthermore, when one constituent element is described as being ‘connected’, ‘coupled’, or ‘attached’ to another constituent element, one constituent element may be connected, coupled, or attached directly to another constituent element or connected, coupled, or attached to another constituent element through yet another constituent element interposed therebetween.

Furthermore, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

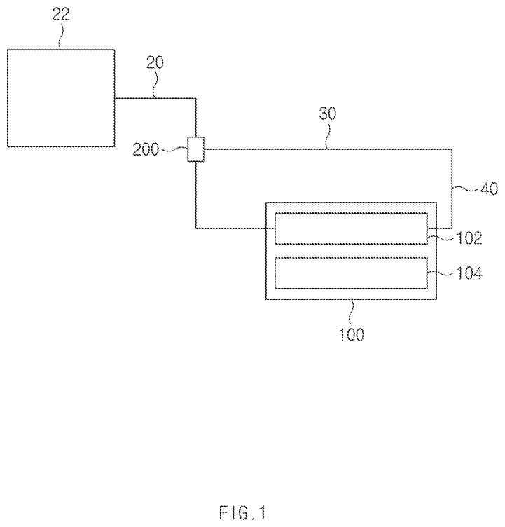

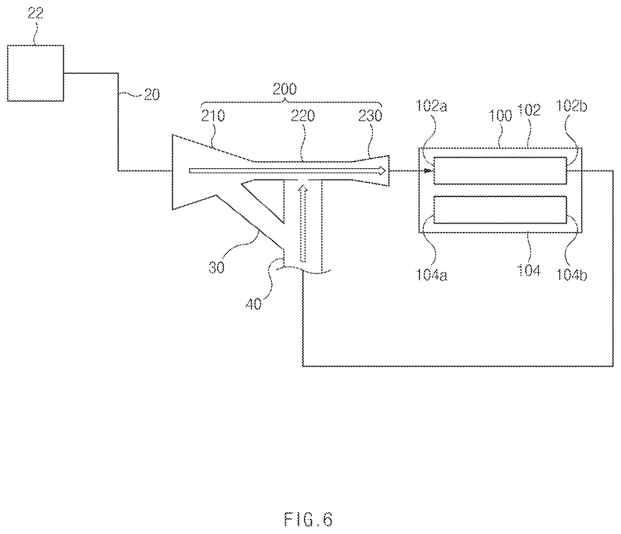

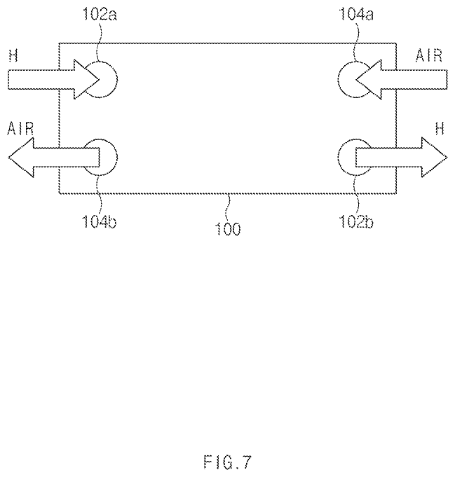

With reference to FIGS. 1 to 10, a fuel cell system according to an exemplary embodiment of the present disclosure includes a fuel cell stack 100 including an anode 102 configured to be supplied with hydrogen, and a cathode 104 configured to be supplied with air, a hydrogen supply line 20 connected to an inlet of the anode 102 and configured to supply hydrogen to the fuel cell stack 100, and a bypass line 30 including one end portion connected to the hydrogen supply line 20 and the other end portion connected to an outlet of the anode 102.

For reference, the fuel cell system according to the exemplary embodiment of the present disclosure may be applied to various vehicles (e.g., construction machines or passenger vehicles), ships, mobility vehicles in aerospace fields to which the fuel cell stack 100 may be applied. The present disclosure is not restricted or limited by the type and properties of an object to which the fuel cell system is applied.

The fuel cell stack 100 refers to a kind of power generation device that generates electrical energy through a chemical reaction of fuel (e.g., hydrogen). The fuel cell stack 100 may be configured by stacking several tens or hundreds of fuel cells (unit cells) in series.

The fuel cell may have various structures configured for producing electricity by an oxidation-reduction reaction between fuel (e.g., hydrogen) and an oxidant (e.g., air).

For example, the fuel cell may include: a membrane electrode assembly (MEA) including catalyst electrode layers in which electrochemical reactions occur and which are attached to two opposite sides of an electrolyte membrane through which hydrogen ions move; a gas diffusion layer (GDL) configured to uniformly distribute reactant gases and transfer generated electrical energy; a gasket and a fastener configured to maintain leakproof sealability for the reactant gases and a coolant and maintain an appropriate fastening pressure; and a separator (bipolar plate) configured to move the reactant gases and the coolant.

In the fuel cell, hydrogen, which is fuel, and air (oxygen), which is an oxidant, are supplied to the anode 102 and the cathode 104 of the membrane electrode assembly, respectively, through flow paths in the separator so that the hydrogen is supplied to the anode 102, and the air is supplied to the cathode 104.

The hydrogen supplied to the anode 102 is decomposed into hydrogen ions (protons) and electrons by catalysts in the electrode layers provided at two opposite sides of the electrolyte membrane. Only the hydrogen ions are selectively transmitted to the cathode 104 through the electrolyte membrane, which is a cation exchange membrane, and at the same time, the electrons are transmitted to the cathode 104 through the gas diffusion layer and the separator which are conductors.

At the cathode 104, the hydrogen ions supplied through the electrolyte membrane and the electrons transmitted through the separator meet oxygen in the air supplied to the cathode 104 by an air supply device, generating a reaction of producing water. As a result of the movement of the hydrogen ions, the electrons flow through external conductive wires, and the electric current is generated as a result of the flow of the electrons.

An air supply line may be connected to the fuel cell stack 100. The air compressed by an air compressor may be supplied to a cathode inlet 104a of the fuel cell stack 100 along the air supply line.

The air supply line may have various structures configured for connecting the air compressor and the fuel cell stack 100. The present disclosure is not restricted or limited by the structure of the air supply line.

Furthermore, an exhaust line may be connected to a cathode outlet 104b of the fuel cell stack 100, and exhaust gas discharged from the fuel cell stack 100 may be discharged along the exhaust line.

The hydrogen supply line 20 is provided to supply hydrogen to the anode 102 of the fuel cell stack 100.

The hydrogen supply line 20 may have various structures configured for connecting a hydrogen supply portion 22 (e.g., a hydrogen tank) and the anode 102 of the fuel cell stack 100. The present disclosure is not restricted or limited by the structure and shape of the hydrogen supply line 20.

According to the exemplary embodiment of the present disclosure, the fuel cell system may include an ejector 200 provided in the hydrogen supply line 20. The hydrogen supplied from the hydrogen supply portion 22 may be supplied to the anode 102 of the fuel cell stack 100 through the ejector 200.

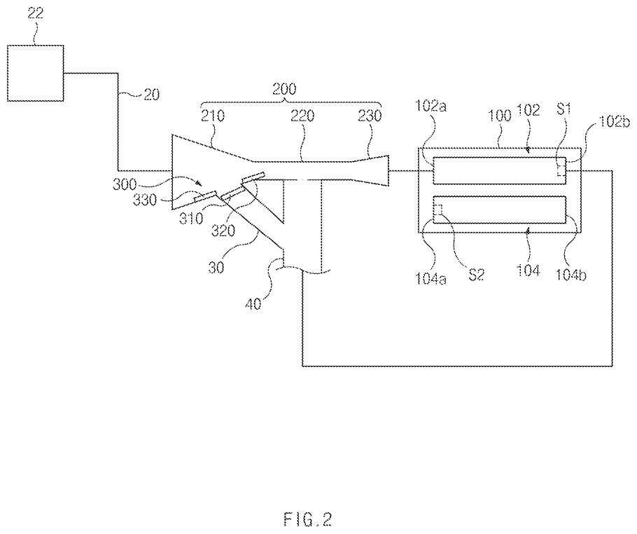

With reference to FIG. 1 and FIG. 2, the bypass line 30 is provided to selectively supply a part of the hydrogen, which is supplied along the hydrogen supply line 20, to the outlet of the anode 102.

One end portion (left end portion based on FIG. 2) of the bypass line 30 is connected to the hydrogen supply line 20, and the other end portion (right end portion based on FIG. 2) of the bypass line 30 is connected to the outlet of the anode 102.

This is based on the fact that because a pressure in an outlet portion region adjacent to the outlet of the anode 102 is lower than a pressure in an inlet portion region adjacent to the inlet of the anode 102 in the initial start mode of the fuel cell stack 100, there is a problem in that air in the cathode 104 is diffused to the anode 102, which causes an unstable output of the fuel cell stack 100 and degradation (corrosion) of the cathode 104.

In contrast, in the exemplary embodiment of the present disclosure, a part of the hydrogen, which is to be supplied to the inlet 102a of the anode 102 along the hydrogen supply line 20, is supplied to the outlet 102b of the anode 102 along the bypass line 30. Therefore, it is possible to obtain an advantageous effect of minimizing a pressure deviation between an anode inlet 102a and an anode outlet 102b of the fuel cell stack 100.

The bypass line 30 may have various structures configured for selectively supplying a part of the hydrogen, which is supplied along the hydrogen supply line 20, to the outlet of the anode 102. The present disclosure is not restricted or limited by the structure of the bypass line 30.

According to the exemplary embodiment of the present disclosure, the fuel cell system may include a recirculation line 40 including one end portion connected to the outlet 102b of the anode 102 and the other end portion connected to the hydrogen supply line 20, the recirculation line 40 being configured to selectively supply the hydrogen, which is discharged from the outlet 102b of the anode 102, back to the inlet 102a of the anode 102. The other end portion of the bypass line 30 may be connected to the recirculation line 40.

The recirculation line 40 may have various structures configured for selectively supplying the hydrogen, which is discharged from the outlet of the anode 102, back to the inlet of the anode 102. The present disclosure is not restricted or limited by the structure and shape of the recirculation line 40.

Furthermore, a gas-liquid separator may be provided in the recirculation line 40 to separate a gaseous component and a liquid component in hydrogen (separate hydrogen and condensate water). The hydrogen discharged from the outlet of the anode 102 may pass through the gas-liquid separator and then be supplied to the inlet of the anode 102 along the recirculation line 40.

According to the exemplary embodiment of the present disclosure, the bypass line 30 and the recirculation line may be connected to the ejector 200.

For example, the ejector 200 may include a first tube portion 210, a second tube portion 220 connected to a downstream side of the first tube portion 210 and having a cross-sectional area smaller than a cross-sectional area of the first tube portion 210, and a third tube portion 230 connected to a downstream side of the second tube portion 220 and having a cross-sectional area larger than the cross-sectional area of the second tube portion 220. The other end portion of the recirculation line may be connected to the second tube portion 220, one end portion of the bypass line 30 may be connected to the first tube portion 210, and the other end portion of the bypass line 30 may be connected to the recirculation line.

Hereinafter, an example will be described in which the bypass line 30 includes an approximately straight shape. According to another exemplary embodiment of the present disclosure, the bypass line may include a curved shape or other shapes.

Meanwhile, in the exemplary embodiment of the present disclosure illustrated and described above, the example is described in which the bypass line 30 and the recirculation line are connected to the ejector 200. However, according to another exemplary embodiment of the present disclosure, the bypass line 30 and the recirculation line 40 may be disposed at an upstream or downstream side of the ejector and directly connected to the hydrogen supply line.

According to the exemplary embodiment of the present disclosure, the fuel cell system may include a valve portion 300 configured to selectively open or close the bypass line 30 based on a pressure difference between the inlet 102a of the anode and the outlet 102b of the anode.

For reference, in the exemplary embodiment of the present disclosure, the operation of opening or closing the bypass line 30 may be defined to include both an operation of turning on or off a flow of hydrogen moving along the bypass line 30 and an operation of adjusting a flow rate of hydrogen moving along the bypass line 30.

The valve portion 300 may have various structures configured for selectively opening or closing the bypass line 30 based on the pressure difference between the inlet 102a of the anode and the outlet 102b of the anode. The present disclosure is not restricted or limited by the type and structure of the valve portion 300.

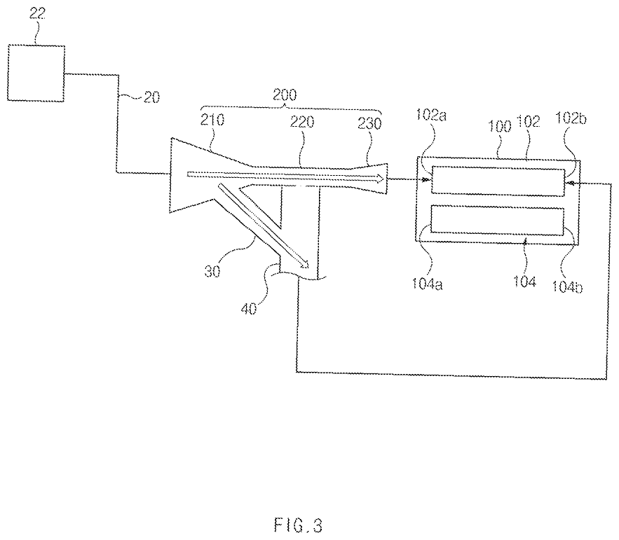

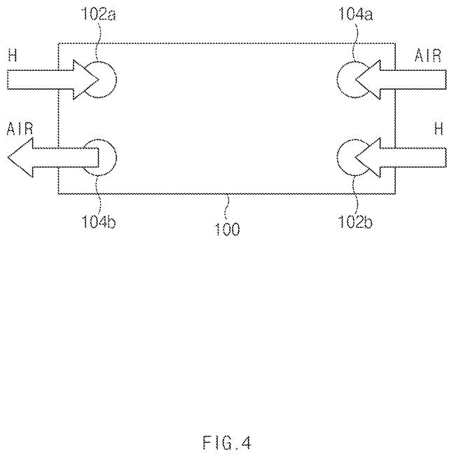

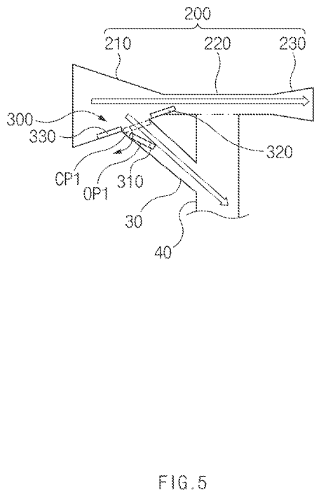

With reference to FIG. 2, FIG. 3, FIG. 4 and FIG. 5, according to the exemplary embodiment of the present disclosure, the valve portion 300 may include a first valve 310 configured to be selectively movable from a first closing position CP1 at which the first valve 310 closes the bypass line 30 to a first opening position OP1 at which the first valve 310 opens the bypass line 30. The first valve 310 may be configured to move to the first opening position OP1 under a condition in which a difference between a supply pressure of hydrogen and a pressure of hydrogen in the recirculation line 40 is a preset first pressure (or a first pressure range). The first valve 310 may be configured to move to the first closing position CP1 under a condition in which the difference between the supply pressure of hydrogen and the pressure of hydrogen in the recirculation line 40 is lower than the first pressure.

The first valve 310 may have various structures configured for moving from the first opening position OP1 to the first closing position CP1. The present disclosure is not restricted or limited by the type and structure of the first valve 310.

For example, the first valve 310 may be configured to open or close the bypass line 30 based on the pressure difference between the inlet 102a of the anode and the outlet 102b of the anode while rotating about one end portion thereof in a hinged manner. The movement (rotation) of the first valve 310 may be elastically supported by an elastic member such as a spring.

The first pressure, which allows the first valve 310 to open the bypass line 30, may be variously changed in accordance with required conditions and design specifications. The present disclosure is not restricted or limited by the operation time point (the first pressure) of the first valve 310.

According to the exemplary embodiment of the present disclosure, the first pressure may be defined to correspond to the initial start mode of the fuel cell stack 100.

In the instant case, the configuration in which the first pressure is defined to correspond to the initial start mode of the fuel cell stack 100 is defined as a configuration in which the first pressure is determined as a pressure corresponding to a difference between the supply pressure of hydrogen to be supplied to the anode 102 and the pressure of hydrogen in the recirculation line 40 during the process of initially starting the fuel cell stack 100.

With the above-mentioned structure, when the difference between the supply pressure of hydrogen to be supplied to the anode 102 and the pressure of hydrogen in the recirculation line 40 is equal to or greater than the preset first pressure (a pressure in the inlet of the anode is higher than a pressure in the outlet of the anode), the first valve 310 may open the bypass line 30, and a part of the hydrogen, which is supplied along the hydrogen supply line 20, may be supplied to the outlet of the anode 102 along the bypass line 30. In contrast, when the difference between the supply pressure of hydrogen to be supplied to the anode 102 and the pressure of hydrogen in the recirculation line 40 is lower than the first pressure, the first valve 310 may close the bypass line 30.

For example, in the initial start mode of the fuel cell stack 100, the pressure in the anode inlet 102a of the fuel cell stack 100 may be defined to be equal to or greater than 146 kPa (based on absolute pressure) and lower than 190 kPa, and the pressure difference between the anode outlet 102b and the cathode inlet 104b of the fuel cell stack 100 may be defined to be 4.5 kPa.

With reference to FIGS. 2 and 6 to 8, according to the exemplary embodiment of the present disclosure, the valve portion 300 may include a second valve 320 configured to be selectively movable from a second closing position CP2 at which the second valve 320 closes the bypass line 30 to a second opening position OP2 at which the second valve 320 opens the bypass line 30. The second valve 320 may be configured to move to the second opening position OP2 (e.g., a right point of an inlet of the bypass line based on FIG. 2) under a condition in which the supply pressure of hydrogen is a predetermined reference pressure. The second valve 320 may be configured to move to the second closing position CP2 under a condition in which the supply pressure of hydrogen is a second pressure (or a second pressure range) lower than the reference pressure.

The second valve 320 may have various structures configured for moving from the second opening position OP2 to the second closing position CP2. The present disclosure is not restricted or limited by the type and structure of the second valve 320.

For example, the second valve 320 may be configured to open or close the bypass line 30 based on the reference pressure while rectilinearly moving in a sliding manner. The movement of the second valve 320 may be elastically supported by an elastic member such as a spring.

The second pressure, which allows the second valve 320 to close the bypass line 30, may be variously changed in accordance with required conditions and design specifications. The present disclosure is not restricted or limited by the operation time point (the second pressure) of the second valve 320.

According to the exemplary embodiment of the present disclosure, the second pressure may be defined to correspond to a general operation mode of the fuel cell stack 100.

In the instant case, the configuration in which the second pressure is defined to correspond to the general operation mode (normal operation mode) of the fuel cell stack 100 is defined as a configuration in which the second pressure is determined as a pressure corresponding to a supply pressure of hydrogen to be supplied to the anode 102 during a general operation of the fuel cell stack 100.

With the above-mentioned structure, the second valve 320 may open the bypass line 30 in the state in which the supply pressure of hydrogen to be supplied to the anode 102 is the first pressure. In contrast, when the supply pressure of hydrogen to be supplied to the anode 102 is the second pressure lower than the reference pressure (e.g., the second pressure lower than the first pressure), the second valve 320 may close the bypass line 30. In the state in which the bypass line 30 is closed by the second valve 320, the bypass flow of hydrogen along the bypass line 30 is restricted, and the hydrogen discharged from the outlet of the anode 102 may recirculate to the inlet of the anode 102 along the recirculation line 40.

For example, in the general operation mode (normal operation mode) of the fuel cell stack 100, the pressure difference between the anode outlet 102b and the cathode inlet 104b of the fuel cell stack 100 may be defined to be lower than 4.5 kPa.

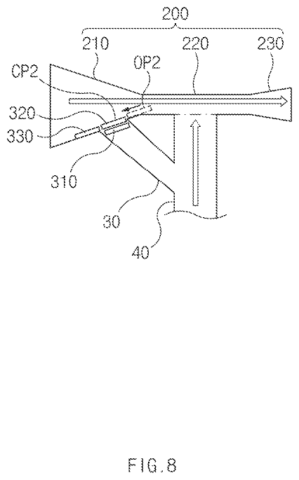

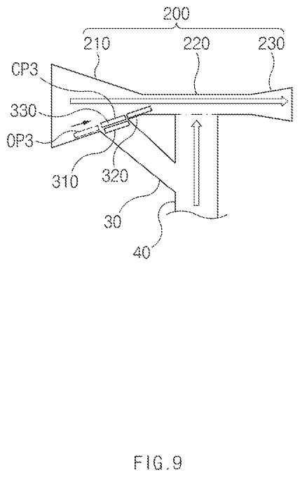

With reference to FIGS. 2 and 9, according to the exemplary embodiment of the present disclosure, the valve portion 300 may include a third valve 330 configured to be selectively movable from a third closing position CP3 at which the third valve 330 closes the bypass line 30 to a third opening position OP3 at which the third valve 330 opens the bypass line 30. The third valve 330 may be configured to move to the third opening position OP3 (e.g., a left point of the inlet of bypass line based on FIG. 2) under a condition in which the supply pressure of hydrogen is equal to or lower than the first pressure. The third valve 330 may be configured to move to the third closing position CP3 under a condition in which the supply pressure of hydrogen is a third pressure (or a third pressure range) higher than the first pressure.

The third valve 330 may have various structures configured for moving from the third opening position OP3 to the third closing position CP3. The present disclosure is not restricted or limited by the type and structure of the third valve 330.

For example, the third valve 330 may be configured to open or close the bypass line 30 based on the third pressure in the inlet 102a of the anode while rectilinearly moving in a sliding manner. The movement of the third valve 330 may be elastically supported by an elastic member such as a spring.

The third pressure, which allows the third valve 330 to close the bypass line 30, may be variously changed in accordance with required conditions and design specifications. The present disclosure is not restricted or limited by the operation time point (the third pressure) of the third valve 330.

According to the exemplary embodiment of the present disclosure, the third pressure may be defined to correspond to a high-output operation mode of the fuel cell stack 100.

In the instant case, the configuration in which the third pressure is defined to correspond to the high-output operation mode (rapid-output operation mode) of the fuel cell stack 100 is defined as a configuration in which the third pressure is determined as a pressure corresponding to a supply pressure of hydrogen to be supplied to the anode 102 during a high-output operation of the fuel cell stack 100.

With the above-mentioned structure, the third valve 330 may open the bypass line 30 in the state in which the supply pressure of hydrogen to be supplied to the anode 102 is equal to or lower than the first pressure. In contrast, when the supply pressure of hydrogen to be supplied to the anode 102 is the third pressure, the third valve 330 may close the bypass line 30. In the state in which the bypass line 30 is closed by the third valve 330, the bypass flow of hydrogen along the bypass line 30 is restricted, and the hydrogen discharged from the outlet of the anode 102 may recirculate to the inlet of the anode 102 along the recirculation line 40.

For example, in the high-output operation mode (rapid-output operation mode) of the fuel cell stack 100, the pressure in the anode inlet 102a of the fuel cell stack 100 may be defined to be equal to or greater than 190 kPa (based on absolute pressure).

As described above, in the exemplary embodiment of the present disclosure, a part of the hydrogen, which is supplied to the inlet of the anode 102 along the hydrogen supply line 20, is selectively supplied to the outlet of the anode 102 along the bypass line 30. Therefore, it is possible to obtain an advantageous effect of minimizing a pressure deviation between the anode inlet 102a and the anode outlet 102b of the fuel cell stack 100.

In the exemplary embodiment of the present disclosure, during the process of initially starting the fuel cell stack 100, a part of the hydrogen, which is to be supplied to the inlet of the anode 102 along the hydrogen supply line 20, is supplied to the outlet of the anode 102 along the bypass line 30. Therefore, it is possible to minimize the diffusion of air to the surface of the anode caused by the pressure difference between the anode outlet 102b and the cathode inlet 104b of the fuel cell stack 100.

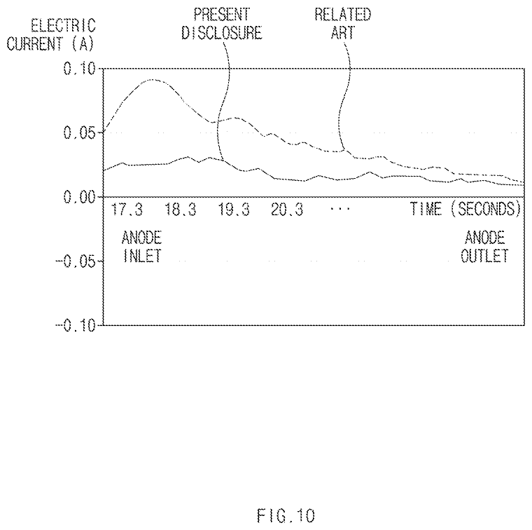

With reference to FIG. 10, unlike the related art in which hydrogen is supplied only to the inlet of the anode 102 during the process of initially starting the fuel cell stack 100, the exemplary embodiment of the present disclosure is configured so that hydrogen is supplied not only to the inlet of the anode 102 but also to the outlet of the anode 102 during the process of initially starting the fuel cell stack 100, which may minimize the pressure deviation between the anode inlet 102a and the anode outlet 102b of the fuel cell stack 100. It may be ascertained that an electric current deviation between a region of the anode inlet 102a (the cell adjacent to the inlet portion) and a region of the anode outlet 102b (the cell adjacent to the outlet portion) is remarkably reduced.

Furthermore, in the exemplary embodiment of the present disclosure, the first valve 310, the second valve 320, and the third valve 330 operate (move from the opening positions to the closing positions) based on the pressure difference between the inlet 102a of the anode and the outlet 102b of the anode. Therefore, it is possible to obtain an advantageous effect of simplifying the structures and operational structures of the first valve 310, the second valve 320, and the third valve 330 and improving the spatial utilization and degree of design freedom.

Meanwhile, in the exemplary embodiment of the present disclosure illustrated and described above, the example has been described in which the first valve 310, the second valve 320, and the third valve 330 operate (move from the opening positions to the closing positions) based on the supply pressure of hydrogen to be supplied to the anode 102. However, according to another exemplary embodiment of the present disclosure, the first valve, the second valve, and the third valve may be operated (moved from the opening positions to the closing positions) by driving power generated by a separate driving source (e.g., a motor or a cylinder).

According to another exemplary embodiment of the present disclosure, a method of controlling the fuel cell system, which includes the fuel cell stack 100 including the anode 102 configured to be supplied with hydrogen and the cathode 104 configured to be supplied with air, the hydrogen supply line 20 connected to the inlet of the anode 102 and configured to supply hydrogen to the fuel cell stack 100, and the bypass line 30 including one end portion connected to the hydrogen supply line 20 and the other end portion connected to the outlet of the anode 102, includes detecting a differential pressure between the outlet of the anode 102 and the inlet 104b of the cathode during the process of initially starting the fuel cell stack 100, and opening the bypass line 30 to supply hydrogen to the outlet of the anode 102 when the differential pressure between the outlet of the anode 102 and the inlet 104b of the cathode is equal to or greater than a predetermined reference differential pressure.

The reference differential pressure, which is a criterion for opening the bypass line 30, may be variously changed in accordance with required conditions and design specifications. The present disclosure is not restricted or limited by the magnitude (or range) of the reference differential pressure.

For example, in the initial start mode of the fuel cell stack 100, the pressure in the inlet of the fuel cell stack 100 may be defined to be equal to or greater than 146 kPa (based on absolute pressure) and lower than 190 kPa, and the reference differential pressure may be defined to be 4.5 kPa. When the differential pressure between the outlet of the anode 102 and the inlet 104b of the cathode is equal to or greater than 4.5 kPa, the bypass line 30 may be opened.

The bypass line 30 may be opened or closed by various valves in accordance with required conditions and design specifications. The present disclosure is not restricted or limited by the type and properties of the valve configured to open or close the bypass line 30. For example, the bypass line 30 may be opened or closed by a typical electronic valve such as a solenoid valve connected to a control unit.

For example, the control unit may open or close the bypass line 30 by controlling the electronic valve on the basis of a signal detected by an outlet pressure sensor S1 provided in the outlet of the anode 102 and a signal detected by an inlet pressure sensor S2 provided in the inlet of the cathode 104.

According to the exemplary embodiment of the present disclosure, the fuel cell system may include the recirculation line including one end portion connected to the outlet of the anode 102 and the other end portion connected to the hydrogen supply line, the recirculation line being configured to selectively supply the hydrogen, which is discharged from the outlet of the anode 102, back to the inlet of the anode 102. The other end portion of the bypass line 30 is connected to the recirculation line 40, and the hydrogen may be supplied to the outlet of the anode 102 via the bypass line 30 and the recirculation line 40 in the opening of the bypass line 30.

The system or device described above may be implemented by hardware components or combinations of hardware components and software components. For example, the devices and components, which have been described in the exemplary embodiments of the present disclosure, may be implemented using one or more general-purpose or special-purpose computers, such as, for example, a processor, a controller, an arithmetic logic unit (ALU), a digital signal processor, a microcomputer, a field programmable gate array (FPGA), a programmable logic unit (PLU), a microprocessor, or any other device configured for responding to and executing instructions. The processing device may run an operating system (OS) and one or more software applications that run on the OS. The processing device may also access, store, manipulate, process, and generate data in response to execution of the software. The software may include a computer program, a piece of code, an instruction, or one or more combinations thereof and independently or collectively instruct or configure the processing device to operate as desired. Software and/or data may be embodied in any type of machine, component, physical or virtual equipment, computer storage medium or device to be interpreted by the processing device or to provide instructions or data to the processing device. The software may also be distributed over network-coupled computer systems so that the software is stored and executed in a distributed fashion. The software and data may be stored in one or more computer-readable recording media.

The method according to the exemplary embodiment of the present disclosure may be implemented in a form of program instructions executable by various computer means and then written in a computer-readable medium. The computer-readable medium may include program instructions, data files, data structures, or the like, in a stand-alone form or in a combination thereof. The medium may continuously store computer-executable programs or temporarily store the programs for execution or download. Furthermore, the medium may include various recording means or storage means in which a single piece of hardware or several pieces of hardware are combined. The medium is not limited to a medium directly connected to any computer system, but may be distributed on a network. Examples of media may include magnetic media such as hard disks, floppy disks, and magnetic tapes, optical recording media such as CD-ROMs and DVDs, magneto-optical media such as floptical disks, ROMs, RAMs, and flash memories and may be configured to store program instructions. While the present disclosure has been described above with reference to the limited embodiments and the drawings, the present disclosure may be variously modified and altered from the present disclosure by those skilled in the art to which the present disclosure pertains. For example, appropriate results may be achieved even though the described technologies are performed in different orders from the described method, the described constituent elements such as the systems, the structures, the apparatuses, and the circuits are coupled or combined in different manners from the described method, and/or the constituent elements are substituted with or replaced by other constituent elements or equivalents.

According to an exemplary embodiment of the present disclosure described above, it is possible to obtain an advantageous effect of ensuring the performance and operational efficiency and improving the stability and reliability.

According to the exemplary embodiment of the present disclosure, it is possible to obtain an advantageous effect of minimizing the hydrogen pressure deviation in the fuel cell stack and improving the stability and reliability.

Among other things, according to the exemplary embodiment of the present disclosure, it is possible to obtain an advantageous effect of minimizing the pressure deviation between the anode inlet and the anode outlet of the fuel cell stack during the process of initially starting the fuel cell stack.

Furthermore, according to the exemplary embodiment of the present disclosure, it is possible to minimize the fluctuation of pressure in the anode and stably ensure the output of the fuel cell stack.

Furthermore, according to the exemplary embodiment of the present disclosure, it is possible to obtain an advantageous effect of improving the durability of the fuel cell stack.

Furthermore, according to the exemplary embodiment of the present disclosure, it is possible to obtain an advantageous effect of more efficiently controlling the working pressure in the anode and improving the degree of freedom of the working pressure in the anode.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A fuel cell system comprising:
a fuel cell stack including an anode configured to be supplied with hydrogen and a cathode configured to be supplied with air;
a hydrogen supply line connected to an inlet of the anode and configured to supply the hydrogen to the fuel cell stack; and
a bypass line including a first end portion connected to the hydrogen supply line and a second end portion connected to an outlet of the anode, wherein the bypass line is provided to selectively supply a part of the hydrogen, which is supplied along the hydrogen supply line, to the outlet of the anode.

2. The fuel cell system of claim 1, including:
a recirculation line including a first end portion connected to the outlet of the anode and a second end portion connected to the hydrogen supply line, the recirculation line being configured to selectively supply hydrogen, which is discharged from the outlet of the anode, back to the inlet of the anode,
wherein the second end portion of the bypass line is connected to the recirculation line.

3. The fuel cell system of claim 2, including:
an ejector mounted in the hydrogen supply line,
wherein the first end portion of the bypass line and the second end portion of the recirculation line are connected to the ejector.

4. The fuel cell system of claim 3, wherein the ejector includes:
a first tube portion, a second tube portion connected to a downstream side of the first tube portion and having a cross-sectional area smaller than a cross-sectional area of the first tube portion; and
a third tube portion connected to a downstream side of the second tube portion and having a cross-sectional area larger than the cross-sectional area of the second tube portion,
wherein the second end portion of the recirculation line is connected to the second tube portion, and
wherein the first end portion of the bypass line is connected to the first tube portion, and the second end portion of the bypass line is connected to the recirculation line.

5. The fuel cell system of claim 4, including:
a valve portion configured to selectively open or close the bypass line based on a pressure difference between the inlet and the outlet of the anode.

6. The fuel cell system of claim 5,
wherein the valve portion includes a first valve configured to be selectively movable from a first closing position at which the first valve closes the bypass line to a first opening position at which the first valve opens the bypass line.

7. The fuel cell system of claim 6,
wherein the first valve is configured to move to the first opening position under a condition in which a difference between a supply pressure of the hydrogen and a pressure of the hydrogen in the recirculation line is a preset first pressure, and
wherein the first valve is configured to move to the first closing position under a condition in which the difference between the supply pressure of the hydrogen and the pressure of the hydrogen in the recirculation line is lower than the first pressure.

8. The fuel cell system of claim 7, wherein the first pressure is defined to correspond to an initial start mode of the fuel cell stack.

9. The fuel cell system of claim 7, wherein the valve portion further includes a second valve configured to be selectively movable from a second closing position at which the second valve closes the bypass line to a second opening position at which the second valve opens the bypass line.

10. The fuel cell system of claim 9,
wherein the second valve is configured to move to the second opening position under a condition in which the supply pressure of the hydrogen is a predetermined reference pressure, and
wherein the second valve is configured to move to the second closing position under a condition in which the supply pressure of the hydrogen is a second pressure lower than the first pressure.

11. The fuel cell system of claim 10, wherein the second pressure is defined to correspond to a general operation mode of the fuel cell stack.

12. The fuel cell system of claim 10, wherein the valve portion includes a third valve configured to be selectively movable from a third closing position at which the third valve closes the bypass line to a third opening position at which the third valve opens the bypass line.

13. The fuel cell system of claim 12,
wherein the third valve is configured to move to the third opening position under a condition in which the supply pressure of the hydrogen is equal to or lower than the first pressure, and
wherein the third valve is configured to move to the third closing position under a condition in which the supply pressure of the hydrogen is a third pressure higher than the first pressure.

14. The fuel cell system of claim 13, wherein the third pressure is defined to correspond to a high-output operation mode of the fuel cell stack.

15. A method of controlling a fuel cell system, which includes a fuel cell stack including an anode configured to be supplied with hydrogen and a cathode configured to be supplied with air, a hydrogen supply line connected to an inlet of the anode and configured to supply the hydrogen to the fuel cell stack, and a bypass line including a first end portion connected to the hydrogen supply line and a second end portion connected to an outlet of the anode, the method comprising:
detecting a differential pressure between the outlet of the anode and an inlet of the cathode during a process of initially starting the fuel cell stack; and
opening the bypass line to supply the hydrogen to the outlet of the anode in response that the differential pressure between the outlet of the anode and the inlet of the cathode is equal to or greater than a predetermined reference differential pressure.

16. The method of claim 15, wherein the fuel cell system includes a recirculation line including a first end portion connected to the outlet of the anode and a second end portion connected to the hydrogen supply line, the recirculation line being configured to selectively supply hydrogen, which is discharged from the outlet of the anode, back to the inlet of the anode,
wherein the second end portion of the bypass line is connected to the recirculation line, and
wherein in the opening of the bypass line, the hydrogen is supplied to the outlet of the anode via the bypass line and the recirculation line.

17. The method of claim 16, further including:
opening the bypass line under a condition in which a difference between a supply pressure of the hydrogen and a pressure of the hydrogen in the recirculation line is a preset first pressure, and
closing the bypass line under a condition in which the difference between the supply pressure of the hydrogen and the pressure of the hydrogen in the recirculation line is lower than the first pressure.

18. The method of claim 17, further including:
opening the bypass line under a condition in which the supply pressure of the hydrogen is a predetermined reference pressure, and
closing the bypass line under a condition in which the supply pressure of the hydrogen is a second pressure lower than the first pressure.

19. The method of claim 17,
opening the bypass line under a condition in which the supply pressure of the hydrogen is equal to or lower than the first pressure, and
closing the bypass line under a condition in which the supply pressure of the hydrogen is a third pressure higher than the first pressure.
